(19) United States
(12) Patent Application Publication
(10) Pub. No.: US 2009/0005883 A1
(43) Pub. Date: Jan. 1, 2009

(54) SYSTEM AND METHOD FOR PROVIDING DEVICE INDEPENDENT CONTROL AND MODIFICATION

(75) Inventors: Andrew H. McMillan, Manchester, NH (US); Kurt Kavanaugh, Kittery, ME (US); Paul Smola, Bedford, NH (US)

Correspondence Address: SHEEHAN PHINNEY BASS & GREEN, PA;c/o PETER NIEVES, 1000 ELM STREET, MANCHESTER, NH, 03105-3701, US

(73) Assignee: Teletrol Systems Inc., Manchester, NH (US)

(21) Appl. No.: 12/147,983

(22) Filed: Jun. 27, 2008

Related U.S. Application Data
(60) Provisional application No. 60/946,621, filed on Jun. 27, 2007.

(51) Int. Cl. G05B 19/00

(52) U.S. Cl. 700/9; 700/87

(57) ABSTRACT

A system and method for providing device independent control and modification is provided, where the system contains a supervisory controller and a first level controller in communication with the supervisory controller. The first level controller contains software therein, wherein the software is the intersection of program code and objects, and wherein objects of the software include at least one device object summarizing properties of the first level controller and limits of the first level controller, and at least one logical element object defining functionality to be performed by the first level controller. Functionality of the first level controller can be changed by changing values of the objects.

### CROSS-REFERENCE TO RELATED APPLICATIONS

This application claims priority to copending U.S. Provisional Application entitled, “SYSTEM AND METHOD FOR PROVIDING DEVICE INDEPENDENT CONTROL AND MODIFICATION,” having Ser. No. 60/946,621, filed Jun. 27, 2007, which is entirely incorporated herein by reference.

### FIELD OF THE INVENTION

The present invention relates to controllers, and more particularly, to changing functionality of first level controllers.

### BACKGROUND OF THE INVENTION

The statements in this section merely provide background information related to the present disclosure and may not constitute prior art.

Traditional control of a first level controller is provided by having software stored within the controller that defines functionality to be performed. As is known by those having ordinary skill in the art, a first level controller is a controller that provides direct access to sensors and other binary, pulse width modulated, analog, or formatted inputs and which directly controls binary, pulse width modulated, analog, or other devices or equipment. In addition, a first level controller possesses communication capability that allows the controller to transfer data between itself and other first level controllers, and/or a supervisory controller in a hierarchical system. A first level controller also possesses the ability to perform data analysis, or data manipulation, or otherwise process and operate on the input data in order to control its outputs.

Unfortunately, modification of a process to be performed by the first level controller requires the changing of software stored on the controller. This changing of the software is required for all activities normally associated with a software development cycle including, for example, specification, design, coding, testing, and upgrading of the software in the target controller.

As is known by those having ordinary skill in the art, changing software stored within the first level controller is, among other things, a tedious task, especially if such a change is to be made system-wide where there are multiple first level controllers. In addition, oftentimes, for small functional changes, the effort and costs associated with the software development and/or changes cannot be justified. Even when justifiable, small changes in software can consume significant time and cost based on the number of process steps to generate new code, and availability of resources.

Another concern with respect to application development is the issue of portability. Applications developed on one platform are typically not readily transportable to another hardware platform without a significant effort and associated cost. These factors typically also have a negative impact on time to market. From this perspective, it is desirable to have an application development mechanism that is readily portable to different devices due to the application development mechanism providing device independent results.

Given the abovementioned, it is desirable to have a mechanism for changing controller functionality, which eliminates much of the effort and time associated with software development processes. Thus, a heretofore unaddressed need exists in the industry to address the aforementioned deficiencies and inadequacies.

### SUMMARY OF THE INVENTION

Embodiments of the present invention provide a system and method for providing device independent control and modification. Briefly described, in architecture, one embodiment of the system, among others, can be implemented as follows. The system contains a supervisory controller and a first level controller in communication with the supervisory controller. The first level controller contains software therein, wherein the software is the intersection of program code and objects, and wherein objects of the software include at least one device object summarizing properties of the first level controller and limits of the first level controller, and at least one logical element object defining functionality to be performed by the first level controller. Functionality of the first level controller can be changed by changing values of the objects.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating a basic control network in which the present first level controller is provided.

FIG. 2 is a schematic diagram providing an example of a first level controller being provided on an ASIC.

FIG. 3 is a table illustrating properties and values of device objects.

FIG. 4 is a table illustrating properties and values of data objects.

FIG. 5 is a table illustrating properties and values of logical element objects.

FIG. 6 is a table illustrating properties and values of physical input objects.

FIG. 7 is a table illustrating properties and values of physical output objects.

FIG. 8 is a table illustrating examples of properties and values of device objects and data objects in accordance with one example.

FIG. 9 is a table illustrating examples of properties and values of logical element objects in accordance with one example.

FIG. 10 is a table illustrating examples of properties and values of physical input objects in accordance with one example.

FIG. 11 is a table illustrating examples of properties and values of physical output objects in accordance with one example.

### DETAILED DESCRIPTION

The present system and method allows for changing functionality performed by a first level controller without the requirement of changing software on the first level controller. Software of the first level controller is the intersection of program code and objects. By carefully, selecting and applying appropriate property values to object properties, the program code is able to effect change in the first level controller in terms of the types of operations performed, along with the order of the operations.

It should be noted that an example of a first level controller is a unitary controller, although the present invention is not limited to being applicable to unitary controllers.

An object, in accordance with the present description, is a collection of one or more related data items with one or more associated properties and/or attributes. An example of an object, among many, would be a temperature setpoint object, having the following properties:
current setpoint value
maximum allowed value
minimum allowed value
default value (when no other value has been assigned)
unit of measurement (degrees C., degrees F., K)
   In addition, an attribute associate with the object could be:
level of precision (0 to 2 decimal places)

The present description provides the example of changing BACnet compatible property values of objects defined within a first level controller in order to change the functionality of the controller. As is known by those having ordinary skill in the art, information in a BACnet system is represented in terms of objects and the objects are monitored and controlled by their properties. It should be noted, however, that the present system and method is not limited to being used on first level controllers having objects with BACnet compatible property values.

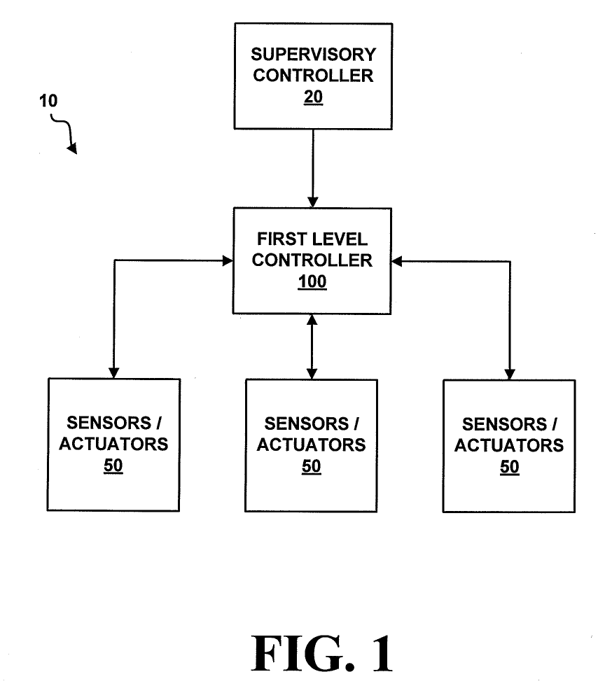

FIG. 1 is a schematic diagram illustrating a basic control network 10 in which the present first level controller 100 is provided. As is shown by FIG. 1, the network 10 contains a supervisory controller 20, the first level controller 100, and a series of sensors 50 and/or actuators. As is known by those having ordinary skill in the art, a basic control network 10 contains a hierarchy of controllers. A top level of the hierarchy includes the supervisory controller 20, while a lower level of the hierarchy includes the first level controller 100. A protocol, such as, but not limited to, the BACnet protocol, may be used for meeting communication needs of the network 10. In accordance with a temperature control example provided herein, use of the BACnet protocol is useful since BACnet has been designed specifically to meet the communication needs of, for example, building automation and control systems for applications such as heating, ventilating, air-conditioning control, lighting control, and access control.

The first level controller 100 may be provided in many different forms. As an example, the first level controller 100 may be provided on a logical board (i.e., printed circuit board) or a logical device, such as an application-specific integrated circuit (ASIC). It should be noted that the first level controller 100 may instead be provided as, or on, a different medium, as long as the basic functionality as described herein is provided and there is no need for changing software to change functionality performed by the first level controller 100, but instead, the changing of values of objects of the first level controller 100 changes the functionality of the first level controller 100.

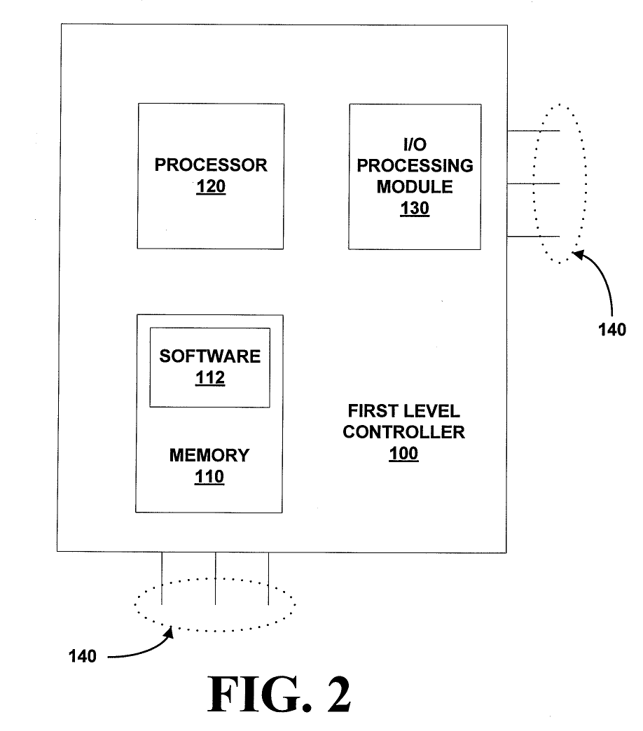

FIG. 2 is a schematic diagram providing an example of the first level controller 100 being provided on an ASIC. As shown by FIG. 2, the first level controller 100 contains a memory 110, a processor 120, an input/output processing module 130, and a series of pins 140. The memory 110 has software 112 stored therein. As was previously mentioned, the software 112 of the first level controller 100 is the intersection of program code and objects.

The input/output processing module 130 provides the ability to sense relay closures, applied input voltages and currents, or other input signals and to convert those input into an appropriately formatted digital data form for subsequent processing. In addition, the input/output processing module 130 can convert properly formatted digital data into relay closures, output voltages or currents, or other signal types for actuation or control of external devices or equipment.

In accordance with one embodiment of the invention, the first level controller 100 contains, among other elements, at least one device object, at least one logical element object, and at least one data object. In accordance with the invention, device objects summarize properties of the first level controller and limits of the same. In addition, the logical element objects define functionality along with a sequence of operations to be performed by the first level controller. The data objects serve as placeholders, or storage locations, where data is to be stored and accessed at a future time in accordance with the functionality of the logical element objects. In accordance with the present invention, the data objects may be binary or analog. Device objects, logical element objects, and data objects are further defined herein, and examples of each are provided.

It should be noted that the data objects may be optional. Specifically, in first level controllers not requiring data to be stored and accessed at a future time, data objects would not be necessary and the data objects would not be provided on the first level controller. In addition, device objects may also be optional.

In accordance with the present invention each device object, data object, and logical element object contains an identification (i.e., ID). Each ID is unique so as to allow for referencing a specific object. In addition, each device object, data object, and logical element object contains a name. Further, each device object, data object, and logical element object contains a description for providing a brief description of the associated object.

### Device Objects

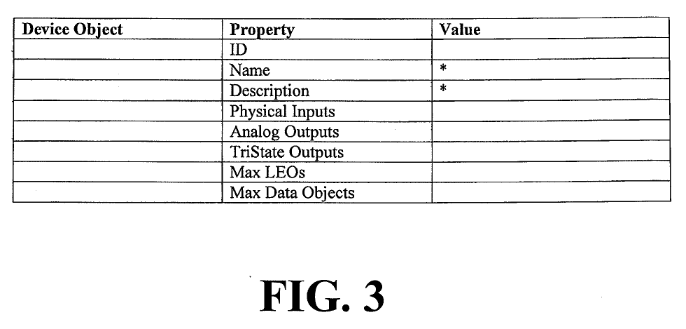

Device objects, as illustrated by FIG. 3, also contain other properties. As an example, a device object may contain a Physical Inputs property, where a number of physical inputs to the first level controller are defined. The device object may also contain a specification of a number of analog outputs and TriState outputs for the first level controller, as identified by an Analog Outputs property and a TriState Outputs property, respectively. A numerical representation of a maximum number of logical element objects (LEOs) and a maximum number of data objects for the first level controller may also be provided as properties of the device object, as shown by the Max LEOs and Max Data Objects properties, respectively.

In accordance with the exemplary embodiment provided hereinafter, values stored in association with the Name and Description properties may be provided by the supervisory controller. It should be noted, however, that in accordance with an alternative embodiment of the invention, all values stored in association with these properties and others, or certain of these values, may be permanently stored and not capable of being modified and/or provided by the supervisory controller.

### Data Objects

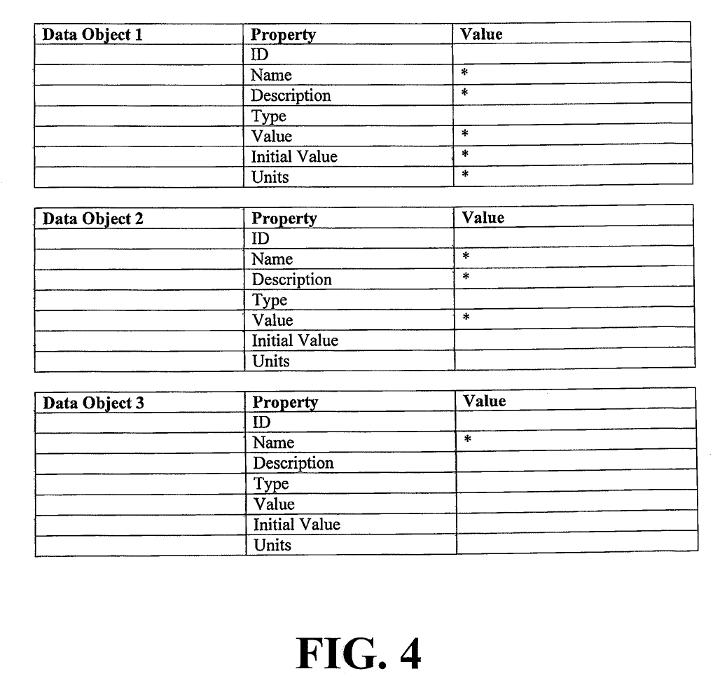

Similar to the device object, as illustrated by FIG. 4, the data objects also contain other properties. Specifically, the data objects also may contain a Type property, a Value property, an Initial Value property, and a Units property. The Type property specifies if the data object is utilized to store analog data or binary data. In addition, the Value and Initial Value properties contain stored values specific to use of the first level controller. Further, the type of units stored by the data object are specified with the Units property. In accordance with the exemplary embodiment provided hereinafter, values stored in association with the Name, Description, Value, Initial Value, and Units properties may be provided by the supervisory controller.

It should be noted, that in accordance with an alternative embodiment of the invention, values stored in association with these properties and others, or certain of these values, may be permanently stored and not capable of being modified. In addition, the data objects may not be visible through the BACnet interface.

### Logical Element Objects

Logical element objects may be provided in one of multiple different classifications. An example of a classification of logical element objects may be an operational logical element object, although many other classifications of logical element objects may be provided, such as, but not limited to, formatting, initiation, termination, messaging, logging, reporting, and loop control.

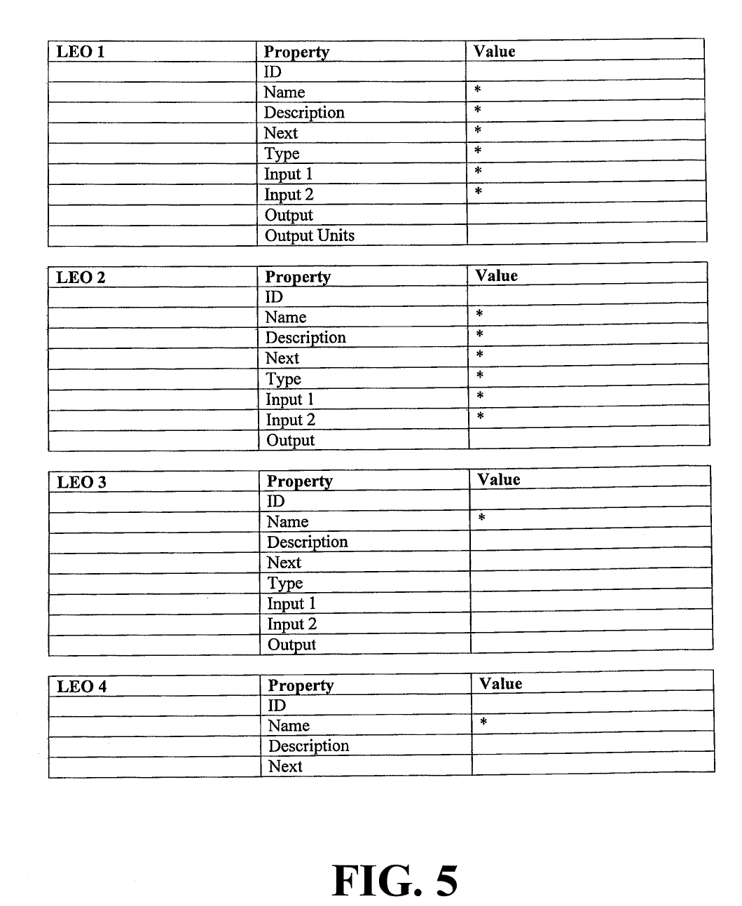

As illustrated by FIG. 5, the logical element object contains a number of other properties. Specifically, the logical element object may contain a Next property, a Type property, an Input 1 property, an Input 2 property, an Output property, and an Output Units property. The Next property stores the identification of another object that is to be called after execution of the current logical element object. In addition, the Type property designates the type of logical element object (i.e., the classification of logical element), such as, but not limited to, a Proportional-Integral-Derivative (PID) loop, a logical AND, or a control gate. Therefore, the Type property specifies the functionality performed by the logical element object, when the logical element object is called. It should be noted that the number of different types of logical element objects is only limited by the type of logical functionality that is to be performed by the first level controller. Other examples of types of logical elements may include, but are not limited to, comparison, conversion, string evaluation, other Boolean operations, arithmetic, trigonometric, and other HVAC primitives.

The logical inputs to the logical element object, which are used for calculation purposes in accordance with the functionality of the logical element object, are specified by the Input 1 and Input 2 properties. In addition, a logical output of the logical element object is specified by the Output property. It should be noted that the Output property changes in accordance with functionality of the logical element object and its inputs. It should also be noted that the logical inputs and logical outputs to the logical element object are not intended to be the physical inputs and physical outputs to the first level controller. Further to the abovementioned, the Output Units property specifies the units in which the Output property is provided.

In accordance with the exemplary embodiment provided hereinafter, values stored in association with the Name, Description, Next, Type, Input 1, and Input 2 properties may be provided by the supervisory controller. It should be noted, however, that in accordance with an alternative embodiment of the invention, all values stored in association with these properties, or certain of these values, may be permanently stored and not capable of being modified.

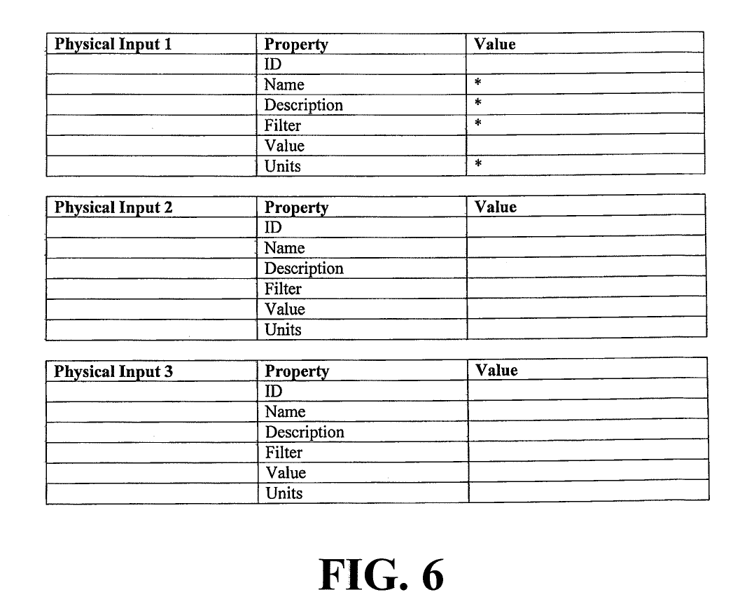

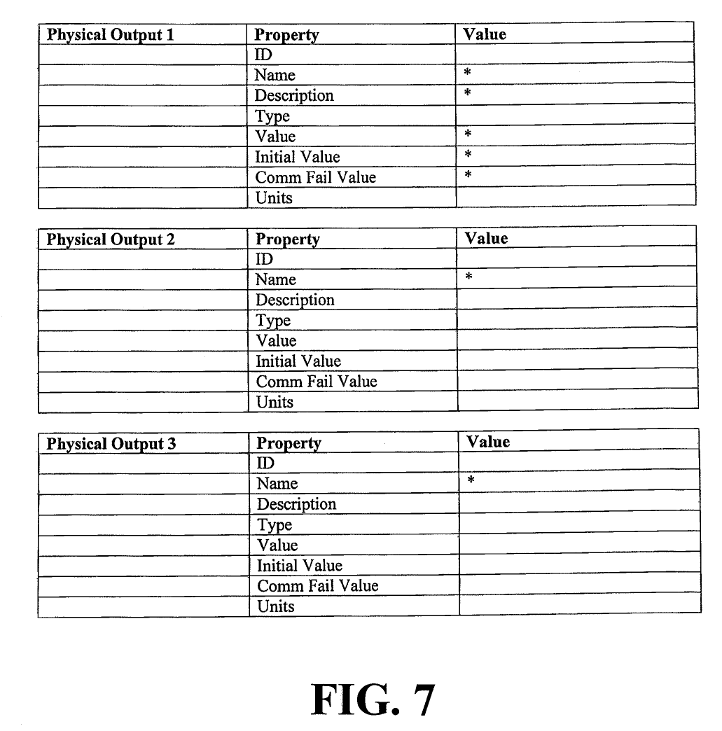

The first level controller may also contain at least one physical input object, as illustrated by FIG. 6, and at least one physical output object, as illustrated by FIG. 7. Specifically, in accordance with one exemplary embodiment of the invention, each physical input to the first level controller is associated with one physical input object. In addition, each physical output to the first level controller is associated with one physical output object.

### Physical Input Object

Referring to FIG. 6, the physical input object contains a series of properties. Similar to the device object, data object, and logical element object, the physical input object contains an ID, a Name, and, a Description property. In addition, the physical input object contains a Filter property, a Value property, and a Units property. The Filter property summarizes a conversion to be performed from one data type to another (e.g., volts to degrees F., volts to air flow in CFM, millivolts to pressure in PSI). In addition, the Value property contains a stored value specific to use of the physical input object. The type of units provided for by the physical input object are specified with the Units property. It should be noted that the Filter, Value, and Units properties are merely examples of properties that may be defined within a physical input object. These properties may vary in accordance with the function for which the first level controller is used.

### Physical Output Object

Referring to FIG. 7, the physical output object contains a series of properties. Similar to the device object, data object, and logical element object, the physical output object contains an ID, a Name, and a Description property. In addition, the physical output object contains a Type property, a Value property, an Initial Value property, a Communication (comm.) Fail Value property (optional), and a Units property. The Type property specifies whether the first physical output is an analog output or a digital output. In addition, the Value property contains a stored value specific to use of the physical output object. The Initial Value property is a default output value. Further, the Comm. Fail Value property contains a predefined value, which the output is set to when communications with the supervisory controller is lost. Finally, the type of units provided for by the physical output object are specified with the Units property.

It should be noted that the type, value, initial value, comm. fail value, and units properties are merely examples of properties that may be defined within a physical output object. These properties may vary in accordance with the function for which the first level controller is used.

The combination of the objects within the first level controller result in an empty device independent program layer device. It should be noted that without populating values of the properties within the first level controller, the controller is not capable of performing functions. However, with providing values to the properties of the objects, the first level controller is capable of performing functions and being modified without modifying software.

### EXAMPLE

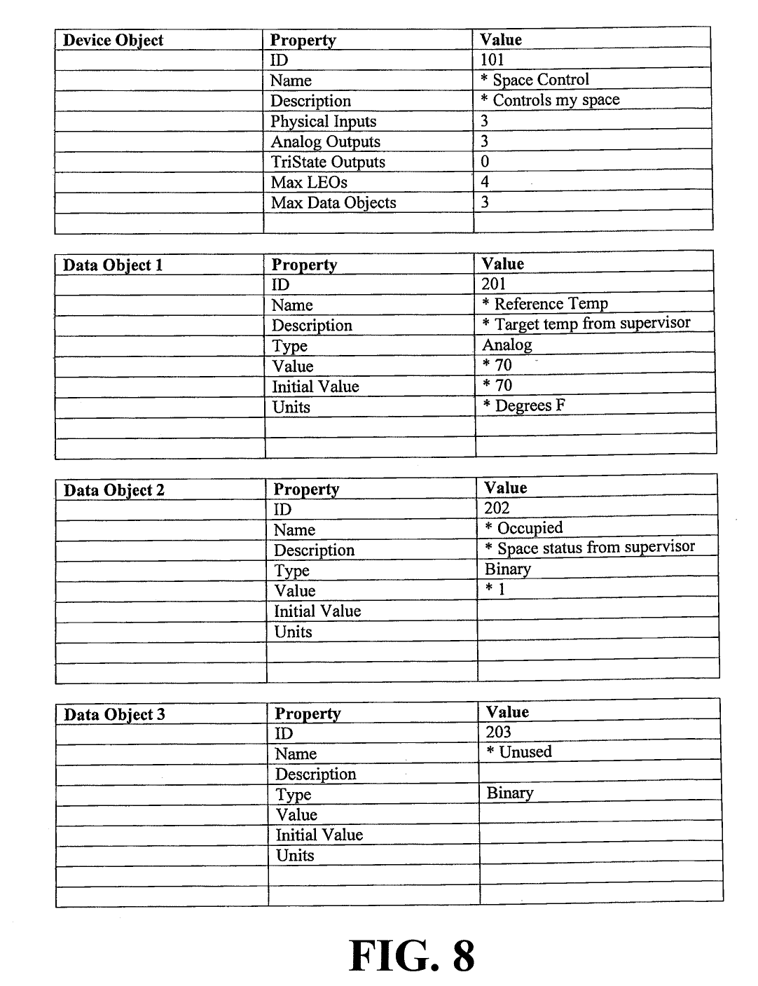

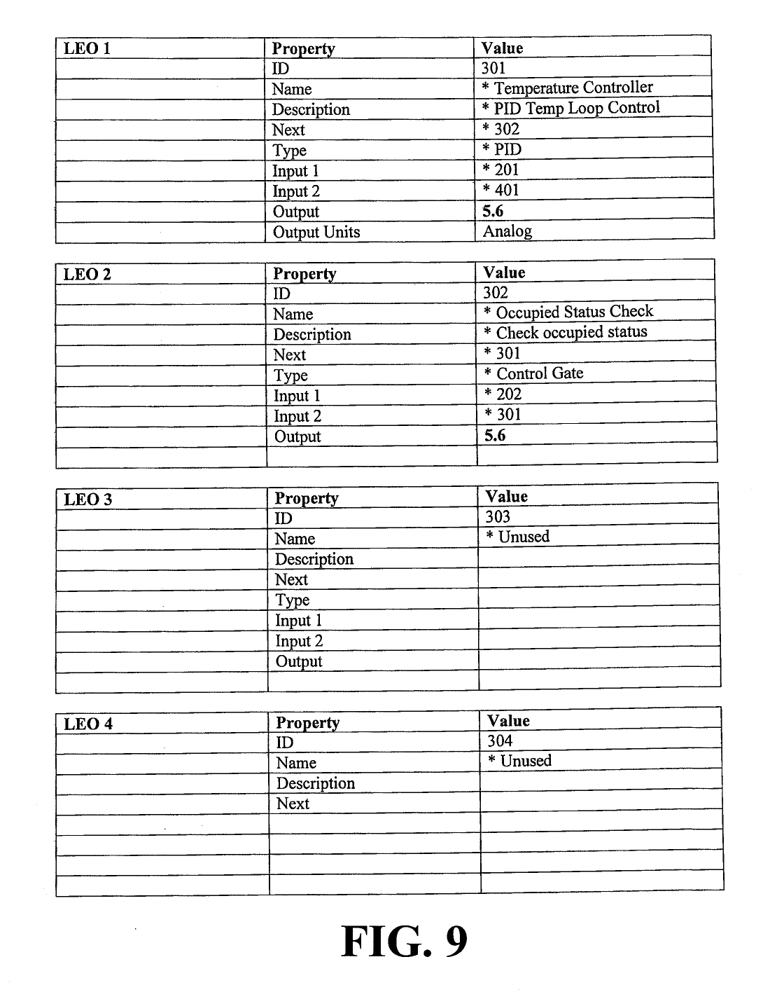

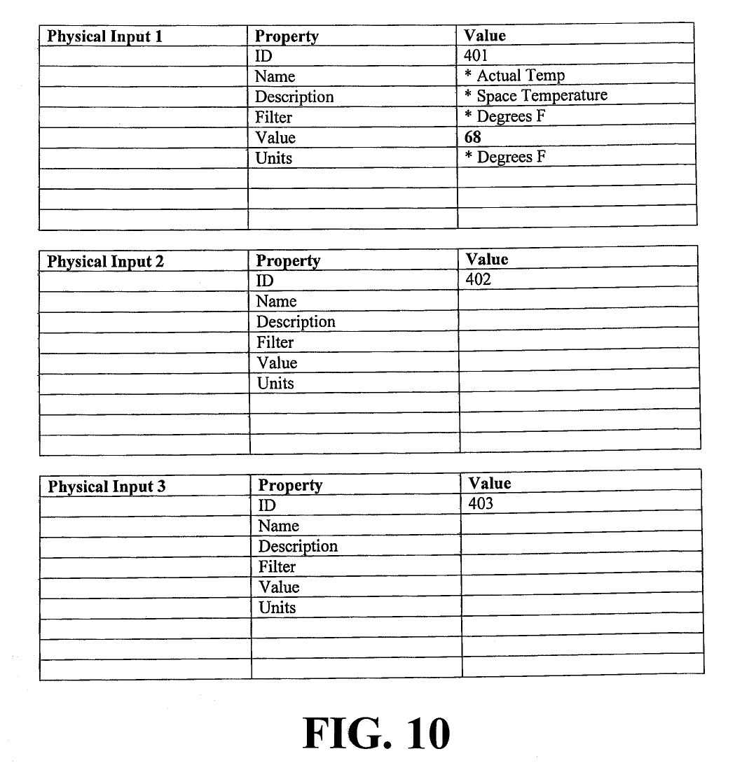

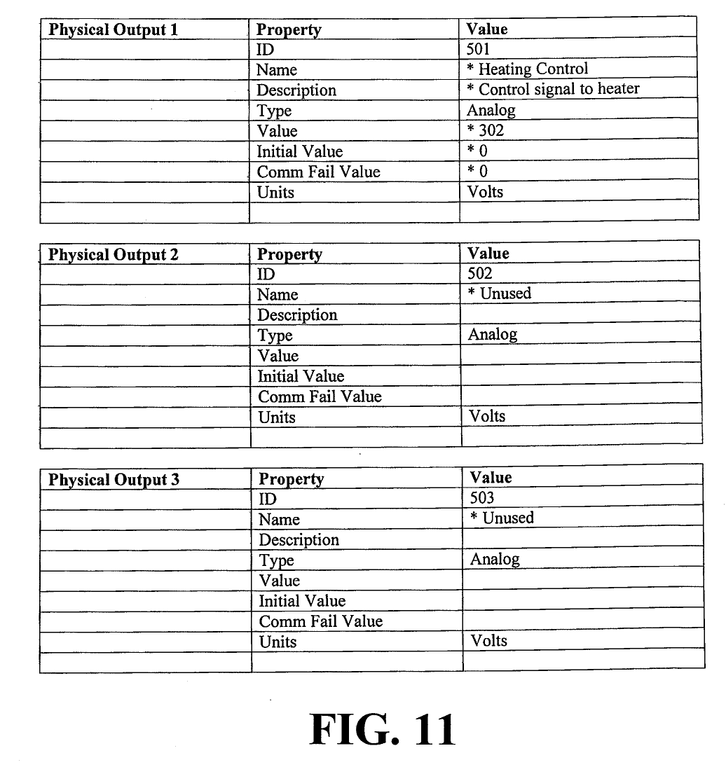

For exemplary purposes, a series of charts are provided and populated to demonstrate objects within the present first level controller. Referring to the figures: FIG. 8 is a chart illustrating a device object and data objects in accordance with the present example; FIG. 9 is a chart illustrating logical element objects in accordance with the present example; FIG. 10 is a chart illustrating physical inputs to the first level controller; and FIG. 11 is a chart illustrating physical outputs to the first level controller. The following is a description of logic performed by the first level controller, as exemplified by FIGS. 8-11. It should be noted that values beginning with an asterisk (*) are values that are provided by a device on the network, such as, but not limited to, the supervisory controller 10 of FIG. 1.

The following provides an example of use of the first level controller in a situation where temperature control is provided within a space. This example is provided with reference to FIGS. 8-11. The first level controller contains a logical board having three universal inputs and three 0-10 volt analog outputs. In the present example the temperature in the room is controlled to seventy (70) degrees when the space is occupied and not controlled when the space is unoccupied. The space is naturally cool so only a heating source is necessary to maintain temperature. In the present example, the first level controller allows a maximum of four (4) logical element objects and three (3) data objects.

### Device Object

Referring to FIG. 8, in accordance with the present temperature control example, the device object identification is 101, while its name is Space Control. The description of the device object is provided as Controls My Space. In accordance with the present invention there are three (3) physical inputs to the first level controller and three (3) analog outputs. The present first level controller does not contain tristate outputs. In addition, the first level controller allows for a maximum of four (4) logical element objects and a maximum of three (3) data objects.

### Data Objects

Referring to FIG. 8, in accordance with the present temperature control example, the first level controller contains three (3) data objects. The first data object has an identification of 201, while its name is Reference Temp. The description of the first data object is provided as Target Temp From Supervisor. The Type of the first data object is set to analog since analog data is stored therein. In addition, the Value property contains the value of 70 since the desired temperature is 70. The Initial Value property also contains the value of 70 since 70 is the desired temperature. Further, the Units property contains the value of degrees Fahrenheit.

The second data object has an Identification of 202, while its Name is Occupied. The Description of the second device object is provided as Space Status From Supervisor. The Type of the second data object is set to binary since binary data is stored therein. In addition, the Value property contains the value of 1, while the Initial value and units properties are left blank. In accordance with the present example, a Value property value of 1 means that-the room/space is occupied, and a 0 value means that the room is not occupied. It should be noted that supervisory controller may provide the value of 1 to the second data object in response to sensing that the room is occupied. Alternatively, if the supervisory controller simply wants the temperature in the room to be maintained at 70, the value of 1 may be provided to the second data object regardless of whether the room is truly occupied.

Referring to the third data object, the third data object has an identification of 203, while its name is Unused. In addition, the type of the third data object is set to binary since binary data is stored therein. As illustrated by FIG. 8, the description property, as well as the value, initial value, and units properties, are left blank.

### Logical Element Objects

Referring to FIG. 9, in accordance with the present temperature control example, the first level controller contains four (4) logical element objects. The first LEO has an identification of 301, while its name is Temperature Controller. The description of the first LEO is provided as PID Temp Loop Control. A Next property, which specifies the object to call after execution of the LEO, is set to 302, which is a second LEO.

The first LEO is a PID loop, as specified by the value of the Type property. By defining the first LEO as a PID loop, the first LEO takes on the attributes of a PID loop controller. In addition, inputs to the first LEO include a first input (i.e., Input 1) of object identification 201 and a second input (i.e., Input 2) of object identification 401. These inputs (i.e., Input 1 and Input 2) are used by the first LEO in execution of a PID loop, where object identification 201 (the first data object) is the reference temperature and object identification 401 (the first physical input object) is the actual space temperature. The output of the first LEO, after performance of the PID loop, is a value of 5.6, although this value varies depending upon the input values and type of LEO. It should be noted that, for exemplary purposes, the output of the first LEO (i.e., output of the PID loop) is within a range of 0 and 10, where the value represents a relationship between the reference temperature and the actual space temperature. Finally, output units of the first LEO are provided in unit Volts.

The second LEO has an identification of 302, while its name is Occupied Status Check. The description of the second LEO is provided as Check Occupied Status. A Next property, which specifies the object to call after execution of the LEO, is set to 301, which is the first LEO.

The second LEO is a control gate, as specified by the value of the Type property. For exemplary purposes, a control gate LEO takes an analog input and conveys the analog input directly to the output of the LEO if, and only if, the second input to the LEO is greater than 0. In addition, if the second input is 0, the output of the control gate LEO is 0. Inputs to the second LEO include a first input (i.e., Input 1) of object identification 202 (second data object) and a second input (i.e., Input 2) of object identification 301 (output of the first LEO). These inputs (i.e., Input 1 and Input 2) are used by the second LEO in execution of the control gate. The output of the second LEO, after performance of the control gate, is listed as 5.6, although this value varies depending upon the input values and type of LEO.

The third LEO and the fourth LEO are not being used, however, their identifications are 303 and 304, respectively.

### Physical Input Objects

Referring to FIG. 10, in accordance with the present temperature control example, the first level controller contains three (3) physical input objects. The first physical input object has an identification of 401, while its name is Actual Temp. The description of the first physical input object is provided as Space Temperature. In addition, the Filter property is set to Degrees Fahrenheit (F.). The Value property contains the value of 68, which is the actual temperature in the room being monitored. Further, the Units property contains the value of Degrees Fahrenheit.

The second and third physical input objects are not being used, however, their identifications are 402 and 403, respectively.

### Physical Output Objects

FIG. 11 is a chart illustrating physical outputs to the first level controller. In accordance with the present temperature control example, the first level controller contains three (3) physical output objects. The first physical output object has an identification of 501, while its name is Heating Control. The description of the first physical output object is provided as Control Signal to Heater. In addition, the Type property of the first physical output object is set to Analog, which is the actual output type of the first physical output.

The Value property of the first physical output object contains the identification 302, which is the value of the second LEO (i e., the control gate LEO). In accordance with the present example, this value is 5.6. The value of the physical output objects may be used to drive a device, such as, in accordance with the present example, a heater. In addition, the Initial Value property contains the value of 0. The Comm. Fail Value property, which is set to a value of 0. Further, the units property contains the value of degrees Fahrenheit.

The second and third physical output objects are not being used (as shown by the Name property), however, the identification for the second physical output object is 502 and the identification for the third physical output object is 503. In addition, both the second and third physical output objects are Analog in Type and have the Units property set as Volts.

It should be noted that the abovementioned was provided for exemplary purposes and is not intended to limit the present invention in any way, but instead was merely set forth for a better understanding of principles of the invention. Many variations and modifications may be made to the above-described embodiments of the invention without departing substantially from the spirit and principles of the invention. All such modifications and variations are intended to be included herein within the scope of this disclosure and the present invention. The first level controller may be used in many other scenarios, and the number and type of objects within the first level controller may differ significantly. In addition, the number of inputs and outputs to the first level controller may also be different, as well as the number of logical element objects and data objects. It should also be noted that the functionality and portions of the first level controller as described herein, may instead be located on a logical board located within a different controller. In such embodiments, having a separate first level controller may not be necessary. Alternatively, both the first level controller and a separate logical board may be provided within the same system.

We claim:

1. A system for providing independent control and modification, comprising:
a supervisory controller; and
a first level controller in communication with the supervisory controller, the first level controller containing software therein, wherein the software is the intersection of program code and objects, and wherein objects of the software comprise at least one logical element object defining functionality to be performed by the first level controller,
wherein functionality performed by the first level controller can be changed by changing values of the objects.

2. The system of claim 1, wherein the first level controller further comprises at least one device object summarizing properties of the first level controller and limits of the first level controller.

3. The system of claim 1, wherein the first level controller further comprises at least one data object, wherein the data object is a storage location for data to be stored and accessed at a future period in accordance with functionality of the logical element object.

4. The system of claim 1, further comprising at least one sensor and/or actuator in communication with the first level controller.

5. The system of claim 1, wherein BACnet protocol is used to provide communication between the supervisory controller and the first level controller.

6. The system of claim 2, wherein properties of the device object are selected from the group consisting of an identification of the device object, a name of the device object, and a description of the device object.

7. The system of claim 2, wherein properties of the device object are selected from the group consisting of a number of physical inputs to the first level controller, a number of analog outputs to the first level controller, a number of TriState outputs to the first level controller, a maximum number of logical element objects to the first level controller, and a maximum number of data objects to the first level controller.

8. The system of claim 3, wherein properties of the data object are selected from the group consisting of an identification of the data object, a name of the data object, and a description of the data object.

9. The system of claim 3, wherein properties of the data object are selected from the group consisting of a type of the data object for specifying if the data object is utilized for storing analog or binary data, a value, an initial value, and type of units stored by the data object.

10. The system of claim 1, wherein properties of the logical element object are selected from the group consisting of an identification of the logical element object, a name of the logical element object, and a description of the logical element object.

11. The system of claim 1, wherein properties of the logical element object are selected from the group consisting of a next property storing identification of another object that is to be called after execution of the current logical element object, a type of logical element object, at least one input property, at least one output property, and an output units property.

12. A first level controller containing software therein, wherein the software is the intersection of program code and objects, and wherein objects of the software comprise:
at least one logical element object defining functionality to be performed by the first level controller,
wherein functionality performed by the first level controller can be changed by changing values of the objects.

13. The first level controller of claim 12, further comprising at least one device object summarizing properties of the first level controller and limits of the first level controller.

14. The first level controller of claim 12, further comprising at least one data object, wherein the data object is a storage location for data to be stored and accessed at a future period in accordance with functionality of the logical element object.

15. The first level controller of claim 13, wherein properties of the device object are selected from the group consisting of an identification of the device object, a name of the device object, and a description of the device object.

16. The first level controller of claim 13, wherein properties of the device object are selected from the group consisting of a number of physical inputs to the first level controller, a number of analog outputs to the first level controller, a number of TriState outputs to the first level controller, a maximum number of logical element objects to the first level controller, and a maximum number of data objects to the first level controller.

17. The first level controller of claim 14, wherein properties of the data object are selected from the group consisting of an identification of the data object, a name of the data object, and a description of the data object.

18. The first level controller of claim 14, wherein properties of the data object are selected from the group consisting of a type of the data object for specifying if the data object is utilized for storing analog or binary data, a value, an initial value, and type of units stored by the data object.

19. The first level controller of claim 12, wherein properties of the logical element object are selected from the group consisting of an identification of the logical element object, a name of the logical element object, and a description of the logical element object.

20. The first level controller of claim 12, wherein properties of the logical element object are selected from the group consisting of a next property storing identification of another object that is to be called after execution of the current logical element object, a type of logical element object, at least one input property, at least one output property, and an output units property.
